(19) United States
(12) Patent Application Publication
(10) Pub. No.: US 2004/0241348 A1
(43) Pub. Date: Dec. 2, 2004

(54) Recording paper, and image recording method and device using the same

(75) Inventors: Chizuru Koga, Ebina-shi (JP); Kiyoshi Hosoi, Ebina-shi (JP); Takashi Ogino, Ebina-shi (JP); Tsukasa Matsuda, Ebina-shi (JP); Taiga Iinuma, Ebina-shi (JP); Takatsugu Doi, Ebina-shi (JP); Ken Hashimoto, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/854,362

(22) Filed: May 27, 2004

(30) Foreign Application Priority Data
May 27, 2003 (JP) 2003-149090

(51) Int. Cl. B41M 5/00

(52) U.S. Cl. 428/32.1

(57) ABSTRACT

A recording paper containing pulp fibers, a filler, and an amine, wherein the amine is a primary, secondary, or tertiary amine represented by the following Formula (α). In the following Formula (α), at least one of substituents represented by R₁, R₂, and R₃ is a hydrocarbon group containing a hydroxyl group. In addition, also provided are an ink jet recording method including recording images on the recording paper; an ink jet recording device equipped with a recording head for ejecting ink onto the recording paper; an electrophotographic recording method including fusing toner images on the recording paper surface; and an electrophotographic recording device including a fusing means that fuses a toner image on the recording paper surface.

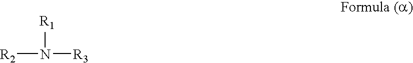

### CROSS-REFERENCE TO RELATED APPLICATIONS

This application claims benefit of and priority to Japanese Patent Application No. 2003-149090, which is incorporated herein by reference in its entirety for all purposes.

### BACKGROUND OF THE INVENTION

1. Field of the Invention

The present invention relates to a recording paper, and to an image recording method, such as an ink jet recording method, or an electrophotographic recording method and an image recording device, using the same. In particular, the invention relates to a so-called regular paper without any special surface coating thereon, an image recording method, such as an ink jet recording method, electrophotographic recording method and an image recording device.

2. Description of the Related Art

An ink jet recording system has advantages such as that it easily allows full color printing, consumes less energy, does not generate noise during recording, and provides printers at a lower production cost. Because of these advantages, ink jet printers have recently been widely used in many offices, frequently together with electrophotographic recording devices, such as laser printers, or copying machines.

Recording media (recording papers) such as so-called regular paper, coated ink jet paper and glossy paper, white film, and transparent film are commonly used in these ink jet recording systems. Especially when such systems are used in an office together with laser printers and copying machines, regular paper is mostly used, since it is economical and readily available, and since images can be easily formed thereon by these electrophotographic recording devices as well. Therefore, it is extremely important to improve the recording suitability of ink jet recording system to regular paper. However, conventional ink jet recording systems have had the following disadvantages in printing on the regular paper.

It is the mainstream method to print images by ejecting an aqueous ink containing a great amount of water in the ink jet recording system. In such a system, printing is always accompanied by addition of a great amount of water onto the recording paper. Paper is a sheet-shaped material in which pulp fibers are bound to each other by hydrogen bonds, and penetration of water molecules into the hydrogen bond network expands an inter-fiber distance and causes dimensional change of the paper. Dimensional change over the entire paper is called “curl”, while unevenness in a local area thereof is called “cockle” or “cockling”. Curl and cockle immediately after printing often cause problems in conveying recording papers and in printing on both faces of the recording papers, in the ink jet printing system. In addition, as the printed ink dries, the water molecules that have penetrated into the regions of the hydrogen bond network evaporate, shortening the inter-fiber distances. During the drying process, new hydrogen bonds are formed at positions different from those before printing, causing a dimensional change different from that immediately after printing. Due to curl and cockle after printing and drying, the quality of the documents printed by such ink jet system becomes lower than that of documents printed by dry printing system such as electrophotographic systems and the like.

For the purpose of overcoming the problems of deformation of printed papers and of curl and cockle, there have be proposed methods of suppressing curl and cockle by relaxing the stress of a sheet by moistening the freshly processed sheet once again (see, for example, Japanese Patent Application Laid-Open (JP-A) No. 3-38375); suppressing curl and cockle by restricting the elongation in water of paper in the CD direction thereof (see, for example, JP-A No. 3-38376); suppressing curl and cockle by restricting the elongation in water of paper both in the MD and CD directions to 1.3 times or less (e.g., JP-A No. 3-199081); suppressing curl and cockle by restricting the elongation in water of paper in the operating direction of ink ejecting portion to 2.0% or less (e.g., JP-A No. 7-276786); suppressing curl and cockle by restricting the elongation in water of paper in the CD direction to 1.8% or less (e.g., JP-A No. 10-46498); and suppressing cockle of a coated-type ink jet recording sheet by controlling the content of pigments in a substrate to within a range of about 5 to 35% by weight and thus maintaining the internal bonding strength of the recording sheet in a range of about 150 to 455 g/cm (e.g., Japanese Patent No. 3172298).

For suppression of curl and cockle generated after a sheet is left out and dried, there has also been proposed a method of suppressing curl and cockle generated after a sheet is left out and dried by controlling to within a predetermined range the irreversible shrinkage percentages of paper in the MD and CD directions when the relative humidity of the environment is altered (e.g., Japanese Patent No. 3127114).

However, although the methods described in the patent references above have been reported to be effective in suppressing curl and cockle, when an ink that is rapidly permeable into paper is used and the amount of ink discharged is great, or when it is required to discharge a great amount of ink per unit of time due to a higher printing speed, curl becomes large, and the papers processed by these methods are not sufficiently usable as documents, since there is a need for suppressing ink penetration into the recording papers.

In addition, although a method described in Japanese Patent No. 3172298 attempts to suppress waviness after printing by controlling the internal bonding strength of a recording paper having an ink receiving layer to within a predetermined range, it has been found that curl, cockle, and wave of printed papers are not sufficiently avoided just by controlling the internal bonding strength. Especially when an ink that is rapidly permeable into paper is used and an amount of ink discharged is great, when an amount of ink discharged per unit of time is great due to high printing speed, the curl of the resulting printed papers increases. In this case, if ink penetration into the recording paper is restricted for suppressing the curl, the drying characteristics of the ink worsen, leading to staining of papers due to transfer of the images printed on a paper to the back face of the next supplied paper during continuous printing, whereby no printed papers that are usable as documents are provided.

Further, the method described in Japanese Patent No. 3127114 does not provide a sufficiently advantageous effect, because if the ink penetration into recording paper is not restricted, when a rapidly permeable ink is used and an mount of ink discharged is great, the ink penetrates into the paper, leading to an increase in absolute mass of the fibers that shrink after drying as a whole, whereby curl after a sheet is left out and dried becomes large.

On the other hand, also in the electrophotographic recording systems, a variation in water content of recording paper is generated by the thermal fusing after toner transfer, frequently leading to curl and cockle of recording papers, and thus improvements in this respect are also desirable in the electrophotographic systems as well.

### SUMMARY OF THE INVENTION

The present invention has been made in view of the above circumstances and achieves the following. Namely, the invention enables printing on both faces of a paper by suppressing generation of curl and cockle of the paper immediately after printing, and suppresses curl and cockle after a sheet is left out and dried during printing by ink jet recording system, and provides a recording paper usable in image formation also by electrophotographic process, and an image recording method and an image recording device using the same, for example, by the ink jet or electrophotographic process.

The present inventors have intensively studied the method for suppressing curl of a regular paper generated immediately after printing and thus making the paper suitable for double-face printing, and for suppressing curl of the paper generated after a sheet is left out and dried and suppressing cockle thereof. As a result, curl and cockle generated immediately after printing and drying are found to be generated, for example, by the drastic expansion in size of the fiber layer that absorbs water in an aqueous ink, and curl and cockle generated after a sheet is left out and dried by shrinkage of the fiber layer that absorbs the ink due to dehumidification.

Further, it has been also found that the dimensional change due to absorption and desorption of water is caused by variation of the distances between hydrogen bonds inside the paper, and it is possible basically to suppress the variation of the distances between hydrogen bonds and reduce curl and cockle after printing and also after drying, by forming a new bond that is not affected by water for suppression of the dimensional change. Furthermore, it has been also found that thermal fusing in the electrophotographic process is also effective in suppressing curl and cockle, as the water in a paper becomes more resistant to dehumidification.

Accordingly, one aspect of the invention is a recording paper comprising pulp fiber, a filler, and an amine, wherein the amine is a primary, secondary, or tertiary amine represented by the following Formula (α).

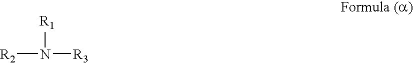

In the Formula (α), at least one of substituents represented by R₁, R₂, and R₃ is a hydrocarbon group containing a hydroxyl group.

Another aspect of the invention is an ink jet recording method comprising ejecting an ink onto the recording paper and recording an image on the recording paper.

Another aspect of the invention is an ink jet recording device provided with one or more of recording head for ejecting ink(s) onto the recording paper.

Another aspect of the invention is an electrophotographic recording method, comprising: electrically charging a surface of an electrostatic latent image bearing body; exposing the surface of the electrostatic latent image bearing body to light to form an electrostatic latent image thereon; developing the electrostatic latent image formed on the surface of the electrostatic latent image bearing body using an electrostatic image developer containing a toner to form a toner image; transferring the toner image, directly or via an intermediate transfer body, onto a surface of the recording paper; and fusing the toner image on the surface of the recording paper.

Still another aspect of the invention is an electrophotographic recording device, comprising: an electrostatic latent image bearing body; a charging means that uniformly charges a surface of the electrostatic latent image bearing body; an exposing unit that exposes the surface of the electrostatic latent image bearing body to light and forms an electrostatic latent image; a developing means that develops the electrostatic latent image formed on the surface of the electrostatic latent image bearing body using an electrostatic image developer and forms a toner image thereon; a transferring means that transfers the toner image, directly or via an intermediate transfer body, onto a surface of the recording paper; and a fusing means that fuses the toner image on the surface of the recording paper.

### BRIEF DESCRIPTION OF THE DRAWINGS

Preferable embodiments of the invention will be described in detail based on the following figures.

FIG. 1 is a perspective view illustrating an apparent configuration of an embodiment of the ink jet recording device according to the present invention.

FIG. 2 is a perspective view illustrating the internal basic configuration of the ink jet recording device shown in FIG. 1.

FIG. 3 is a schematic diagram illustrating an embodiment of an electrophotographic recording device according to the invention.

### DETAILED DESCRIPTION OF THE INVENTION

Hereinafter, the invention will be described separately with respect to the recording paper and to the image recording method (image recording device).

Recording Paper

The recording paper according to the invention is a base paper (e.g., regular paper) containing at least pulp fibers and a filler, at least one face of which is coated or impregnated with the following amine represented by Formula (α).

The recording paper according to the invention containing an amine represented by the following Formula (α) is prevented from curl and cockle. The mechanism is assumed to be the followings.

The amine represented by the following Formula (α) can penetrate into the space among the cellulose fibers of base paper due to the presence of a nitrogen atom having a high affinity to cellulose, where a hydroxy group contained in the substituent of the nitrogen atom form a hydrogen bond with a hydroxyl group of cellulose, and the intramolecular nitrogen atom also binds physically to the fiber due to its high affinity to the hydroxy hydrogen atom of cellulose. With these two bonds combined, the amine represented by the following Formula (α) orients itself in the space among cellulose fibers and forms a structure cross-linking the cellulose fibers. Accordingly, use of the amine essentially suppresses the variation of the hydrogen bond distances among cellulose fibers, enabling to reduce curl and cockle after printing or after drying.

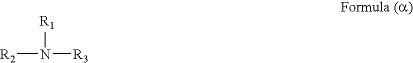

The amine represented by the Formula (α) above is a primary, secondary, or tertiary amine, and at least one of three substituents represented by R₁, R₂, and R₃ is a hydrocarbon group containing a hydroxyl group.

The “hydrocarbon group containing a hydroxyl group” in the amine represented by the Formula (α) above means a hydrocarbon group known in the art having at least one hydroxyl group, and the structure thereof is not particularly limited.

Based on the consideration described above, for facilitating formation of cross-linking structure with cellulose fibers, the amine represented by the Formula (α) above preferably satisfies the following requirements (1) to (4): (1) a hydroxyl group is located at the utmost outer position of the amine molecule; (2) at least one hydroxyl group is contained in each substituent, R₁, R₂, or R₃; (3) the substituents R₁, R₂, and R₃ are not sterically bulky and other molecules and polymers can assess to the nitrogen atom located at the center of the amine molecule; and for controlling cross-linking distances when the cellulose fibers are cross-linked at a suitable length, not too long or not too short, (4) among the substituents R₁, R₂, and R₃, at least the substituent having a hydroxyl group has a suitable length.

However, with respect to the requirement (2), it is practically preferable for any two of the three substituents R₁, R₂, and R₃, to contain a hydroxyl group. It is because an amine having at least one hydroxyl group in each of the substituents R₁, R₂, and R₃ sometimes decomposes over time, depending on the molecule structure thereof, and the decomposition products cause yellowing.

For satisfying the requirement (1), the hydroxyl group is preferably located at a terminal of the hydrocarbon group containing a hydroxyl group. If a hydroxyl group is located inside a hydrocarbon group containing another hydroxyl group at a terminal, the functional group at a terminal may interfere formation of the cross-linking structure between the hydroxyl group inside and cellulose fiber.

For satisfying the requirement (3) above, the hydrocarbon group containing a hydroxyl group is preferably a hydrocarbon group containing a hydroxylalkyl group, and more preferably a hydroxyalkyl group per se.

If the hydrocarbon group containing a hydroxyl group is, for example, an aromatic group having a hydroxyl group, the substituent R (the “substituent R” means at least one of the substituents R₁, R₂ and R₃; hereinafter, the same definition applies) may prohibit access of other molecules and polymers to the nitrogen atom located at the center of the amine molecule due to its steric bulkiness. Thus, the hydroxyalkyl group is preferably a straight chain group rather than a branched chain group from the viewpoint of reducing steric bulkiness.

Further, for satisfying the requirement (4) above, the hydrocarbon group containing a hydroxyl group, if it is a straight chain hydroxyalkyl group, preferably having 1 to 5 carbon atoms, more preferably having 1 to 3 carbon atoms, and still more preferably having 1 to 2 carbon atoms.

If the carbon number is zero, i.e., if a hydroxyl group is bound directly to the nitrogen atom, the cross-linking distance between the amine molecule and a cellulose fiber may be too short, while if the carbon number is more than 5, the cross-linking distance may be too long.

In addition, if the hydrocarbon group containing a hydroxyl group has a structure other than the straight chain hydroxyalkyl group or a hydrocarbon group containing a straight chain hydroxyalkyl group (e.g., a benzene ring group having a straight chain hydroxyalkyl group or the like), the length of the hydrocarbon group containing a hydroxyl group in such a structure is preferably corresponding to that of the hydroxyalkyl group having 1 to 5 carbon atoms, from the viewpoint similar to above.

More specifically, the amine represented by the Formula (α) above is preferably an amine represented by the following Formula (1) or (2).

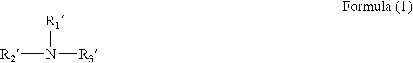

The amine represented by the Formula (1) is a primary, secondary, or tertiary amine, and at least one of three substituents represented by R₁′, R₂′, and R₃′ in the Formula (1) is a hydrocarbon group containing a hydroxyl group, and all of the three substituents above do not contain an alkyl group having —CO₂M or —SO₃M at terminals thereof, M being an atom or atomic group selected from the group consisting of hydrogen, alkali metals, alkali earth metals, ammonium, and organic amines.

The amine represented by the Formula (1) is not particularly limited, if at least one substituent among the three substituents R₁′, R₂′, and R₃′ bound to the nitrogen atom is a hydrocarbon group containing a hydroxyl group, and all of the three substituents above do not contain an alkyl group having —CO₂M or —SO₃M at terminals thereof, M being an atom or atomic group selected from the group consisting of hydrogen, alkali metals, alkali earth metals, ammonium, and organic amines, and for example, may be an amine of which the terminals of the three substituents above are unsubstituted or bound to other substituents (e.g., hydroxyl group).

With respect to the amine represented by the Formula (1), the number of the hydrocarbon groups containing a hydroxyl group contained in the amine molecule and specific structures of the hydrocarbon groups containing a hydroxyl group are preferably similar to those of the amine represented by the Formula (α).

Specific examples of the amine molecules represented by the Formula (1) include bis(hydroxyalkyl)monoalkylamines such as N-ethyldiethanolamine; tris(hydroxylalkyl)amines such as tris(2-hydroxyethyl)amine, 1-[N,N-bis(2-hydroxyethyl)amino]-2-propanol, and 2,2-bis(hydroxymethyl)-2,2″, 2′-nitriloethanol; and monohydroxyalkylamines such as 2-aminoethanol and others.

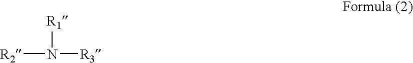

The amine represented by the Formula (2) is a primary, secondary, or tertiary amine, and at least one of three substituents represented by R₁, R₂, and R₃ in the Formula (2) is a hydrocarbon group containing a hydroxyl group, and at least one of the three substituents represented by R₁″, R₂″, and R₃″ is a hydrocarbon group containing an alkyl group having —CO₂M or —SO₃M at a terminal thereof, M being an atom or atomic group selected from the group consisting of hydrogen, alkali metals, alkali earth metals, ammonium, and organic amines.

With respect to the amine represented by the Formula (2), the number of the hydrocarbon groups containing a hydroxyl group contained in the amine molecule and specific structures of the hydrocarbon groups containing a hydroxyl group are preferably similar to those of the amine represented by the Formula (α).

Different from the amine represented by the Formula (1), the amine represented by the Formula (2), of which at least one of three substituents represented by R₁″, R₂″, and R₃″ is a hydrocarbon group containing an alkyl group having —CO₂M or —SO₃M at a terminal thereof, M being an atom or atomic group selected from the group consisting of hydrogen, alkali metals, alkali earth metals, ammonium, and organic amines (hereinafter, referred to as an “alkylcarboxylic acid derivative group” or “alkylsulfonic acid derivative group”), exerts an advantageous effect of improving the image density by the ink jet recording system.

The favorable effect of improving the image density is likely to reflect the capability of the —CO₂M or —SO₃M group contained in the alkylcarboxylic or alkylsulfonic acid derivative group to accelerate coagulation of the colorants (e.g., pigments) when brought into contact with ink.

More specifically, the image density improving effect is likely due to the following phenomenon.

When an ink droplet ejected as a microfine droplet from a recording head and attached on a recording paper is brought into contact with the amine containing the alkylcarboxylic acid and/or alkylsulfonic acid derivative groups during printing by the ink jet process, the —CO₂M or —SO₃M groups contained in the amine molecule interferes with the dispersion stability of colorants in ink, and accelerate coagulation of the colorants. Thus, the phenomenon seems to cause deposition of the colorants on the surface of the recording paper and improve the image density.

The alkylcarboxylic acid or alkylsulfonic acid derivative group contained in the amine molecule represented by the Formula (2) above may contain a hydroxyl group. However in such a case, the hydroxyl group can not be located at a terminal, and thus the amine preferably does not contain a hydroxyl group.

The number of the hydrocarbon group containing a hydroxyl group contained in the amine molecule represented by the Formula (2) above is most preferably two as described above, and thus the number of the alkylcarboxylic acid or alkylsulfonic acid derivative groups contained in the amine molecule is preferably one.

Specific examples of the amine molecules represented by the Formula (2) above include N,N-bis(hydroxyethyl)glycine, N,N-bis(hydroxyethyl)glycine sodium salt, N,N-bis(hydroxyethyl)glycine ammonium salt, N,N-bis(hydroxymethyl)glycine, N,N-bis(hydroxymethyl)glycine sodium salt, N,N-bis(hydroxymethyl)glycine ammonium salt, N,N-bis(hydroxyethyl)-2-aminoethanesulfonic acid, N,N-bis(hydroxyethyl)-2-aminoethanesulfonic acid sodium salt, N,N-bis(hydroxyethyl)-2-aminoethanesulfonic acid ammonium salt, N,N-bis(hydroxymethyl)-2-aminoethanesulfonic acid, N,N-bis(hydroxymethyl)-2-aminoethanesulfonic acid sodium salt, N,N-bis(hydroxymethyl)-2-aminoethanesulfonic acid ammonium salt, and tricine sodium salt {N-[tris(hydroxymethyl)methyl]glycine sodium salt}.

More preferable amine molecules among them are N,N-bis(hydroxyalkyl)glycine derivatives and N,N-bis(hydroxyalkyl)-2-aminoethanesulfonate derivatives, and in particular, the hydroxyalkyl group in these amine derivative molecules is preferably hydroxyethyl.

The amine represented by the Formula (α) described above is preferably in a solid state at normal temperature, if it presents as a single substance. From this viewpoint, the melting or decomposition point of the amine is preferably 50° C. or more, more preferably 100° C. or more, and still more preferably 180° C. or more.

When an amine is a compound having both melting and decomposition points, “the melting or decomposition point of the amine” means the lower temperature of them.

When the melting or decomposition point of an amine is 50° C. or more, the amine represented by the Formula (α) above is solid under the commonly used environment, exerting an effect similar to that of a paper-strength additive by being aligned and connected among cellulose fibers. Accordingly, such amines provide a greater effect of suppressing curl and cockle, compared to the amines having a melting or decomposition point of less than 50° C. In addition, amines having a melting or decomposition point of 50° C. or more function as a paper-strength additive, and thus such recording papers containing the amine prevent curl and cockle, even when images are printed or painted multiply over images already printed thereon. The amines represented by the Formula (2) having a melting or decomposition point of 50° C. or more include the amines exemplified above.

The content (amount of application) of the amine represented by the Formula (α) is preferably 0.1 to 3 g/m², and more preferably 0.2 to 2 g/m² as dry mass. An application amount of less than 0.1 g/m² is not favorable, as it cannot prevent curl and cockle sufficiently. An application amount of over 3 g/m² is also not favorable for documentation papers, as it may weaken the stiffness thereof.

The amine represented by the Formula (α) may be applied or impregnated directly as an aqueous solution as dissolved in water on recording papers, or as a mixture together with a water-soluble binder. Examples of the binders include oxidized starches, phosphorylated starches, proprietary denatured starches, cationized or various modified starches, polyethylene oxide, polyacrylamide, sodium polyacrylate, sodium alginate, hydroxymethylcellulose, carboxymethylcellulose, methylcellulose, and polyvinylalcohol or the derivatives thereof. These binders may be used alone or as a mixture thereof, and are not limited to these materials.

The base paper used for preparing the recording paper according to the invention is a base paper containing pulp fibers and a filler.

The pulp fibers used for the base paper include chemical pulps such as bleached hardwood Kraft pulp, unbleached hardwood Kraft pulp, bleached softwood Kraft pulp, unbleached softwood Kraft pulp, bleached hardwood sulfite pulp, unbleached hardwood sulfite pulp, bleached softwood sulfite pulp, and unbleached softwood sulfite pulp; and pulps prepared by chemically processing fibrous materials such as wood, cotton, hemp, and other fibrous materials.

In addition, ground wood pulps prepared by mechanically pulping woods and chips; chemimechanical pulps prepared by mechanically pulping chemical-impregnated woods and chips; thermomechanical pulps prepared by pulping the chips slightly softened by previous steaming in a refiner, and the like may also be used. These pulps may be prepared from a virgin pulp or combined with waste paper pulps if desired.

In particular, the virgin pulp is preferably bleached by the method of using only chlorine dioxide but not chlorine gas (Elementally Chlorine Free: ECF) or by the method of using ozone/hydrogen peroxide or the like but not a chlorine compound (Total Chlorine Free: TCF).

Raw materials for the waste paper pulps include unprinted waste papers of extremely high-quality, high-quality, medium-grade white paper, low-grade, and other white papers that are cut, damaged, and irregular in size; high-quality waste papers such as woodfree and coated woodfree papers that are printed or copied; waste papers printed with inks such as aqueous and oil-based inks or with lead pencils; newspaper waste papers containing advertising leaflets such as printed woodfree papers, woodfree coated paper, wood-containing paper, and wood-containing coated paper; and waste papers of wood-containing papers, coated wood-containing papers, wood papers, and the like, generated in bookmakers, print shops, cutting facilities, and the like.

The waste paper pulps used for base papers are preferably the pulps of raw waste papers bleached at least either by an ozone or hydrogen peroxide bleaching treatment. For obtaining recording papers higher in whiteness, it is preferable to have a blending ratio of the waste papers obtained by the bleaching treatment above in a range of about 50 to 100%. Further from the viewpoint of resource recycling, the blending ratio of the waste paper pulps above is preferably in a range of about 70 to 100%.

The ozone-bleaching treatment decomposes fluorescence dyes and the like that are commonly contained in woodfree papers, while the hydrogen peroxide bleaching treatment prevents yellowing caused by the alkalis used in the deinking process.

In particular, combined use of these two treatments allows easier deinking of waste papers and at the same time improves the whiteness of the pulps obtained. In addition, the treatment also decomposes and eliminates the chlorine compounds remaining in the pulps and thus is very effective in reducing the content of organic halogen compounds in the waste papers that are bleached with chlorine.

In addition to pulp fibers, a filler may be added to the base paper, for adjustment of the opacity, whiteness, and surface smoothness thereof It is preferably to use a non-halogen filler particularly if reduction in the halogen content of recording papers is desirable.

Examples of the usable fillers include inorganic pigments such as heavy calcium carbonate, light calcium carbonate, chalk, kaolin, calcined clay, talc, calcium sulfate, barium sulfate, titanium dioxide, zinc oxide, zinc sulfide, zinc arbonate, aluminium silicate, calcium silicate, magnesium silicate, synthetic silica, aluminum hydroxide, alumina, sericite, white carbon, saponite, calcium monmorillonite, sodium monmorillonite, and bentonite; and organic pigments such as acrylic plastic pigments, polyethylene, and urea resins. If waste paper pulps are blended to the base paper, the blending amount of the waste paper pulps should be determined by previously estimating the ashes contained in the raw waste-paper pulps.

The blending rate of fillers is not particularly limited, but preferably in a range of about 1 to 80 parts by weight with respect to 100 parts by weight of the pulp fiber above.

During sheeting, the fiber orientation ratio of the base paper is controlled in a range of about 1.0 to 1.55, preferably in a range of about 1.0 to 1.45, and more preferably in a range of about 1.0 to 1.35. Proper control of the fiber orientation in this manner allows reduction in the frequency of curls of the recording papers after printed by the ink jet process.

The fiber orientation ratio above is a fiber orientation ratio as determined by the ultrasonic transmission velocity method, i.e., a value calculated by dividing the ultrasonic transmission velocity in the MD direction (the traveling direction of the paper in sheeting machine) of the recording paper by that in the CD direction (the direction orthogonal to the MD direction), as defined in the following Equation (1):

Fiber orientation ratio of base paper (T/Y ratio) as determined by the ultrasonic transmission velocity method]=(Ultrasonic transmission velocity in MD direction)/(Ultrasonic transmission velocity in CD direction Equation (1)

The fiber orientation ratio by the ultrasonic transmission velocity method is determined by the Sonic Sheet Tester (trade name, manufactured by NOMURA SYOJI. Inc.).

An internal sizing agent is preferably added to the recording paper according to the invention, and examples of the internal sizing agents include those used in neutral sheeting processes such as neutral rosin-based sizing agents, alkenylsuccinic anhydrides (ASAs), alkylketene dimers (AKDs), and petroleum resin-based sizing agents.

The sizing degree of recording papers can be adjusted only by properly selecting the type and blending ratio of the binders above. However, if the sizing degree may not be adjusted sufficiently only with the binders above, a surface sizing agent may be added additionally. Examples of the surface sizing agents include rosin-based sizing agents, synthetic sizing agents, petroleum rosin-based sizing agents, neutral sizing agents, starch, polyvinylalcohol, and the like. For the purpose of reducing the halogen content of recording papers, it is preferable to use an internal or surface sizing agent that does not contain halogen. Specifically, resin-based sizing agents, synthetic sizing agents, petroleum resin-based sizing agents, neutral sizing agent, and the like may be used for that purpose. Use of a neutral sizing agent is preferable from the viewpoint of improving the shelf life of recording papers. The sizing degree is adjusted by controlling the blending amount of sizing agents.

The recording papers according to the invention may be prepared by coating a solution containing the components above on a base paper by using a coating means commonly used in the art such as size press, shim size, gate roll, roll coater, bar coater, air knife coater, rod blade coater, and blade coater. The recording papers are obtained after drying in the subsequent drying step.

The recording paper according to the invention may be used for image formation by the electrophotographic recording process, in addition to printing by the ink jet recording system. In such a case, for the purpose of improving the transfer and graininess of the toner, it is preferable to make the recording paper have a surface smoothness in a range of about 20 to 100 seconds or less, and more preferable in a range of about 70 to 100 seconds. A surface smoothness of less than 20 seconds sometimes leads to aggravated graininess. If the surface smoothness is higher than 100 seconds, the recording paper should be pressed in wet state under high pressure during the manufacturing process for obtaining high smoothness, consequently reducing the opacity of the resulting paper or increasing the curl thereof after printing by the ink jet printing process. Thus, such papers are not favorable as recording papers. The surface smoothness means a value determined by using a BEKK smoothness tester according to the smoothness test procedure known in the art.

The microformation index of the recording paper according to the invention is preferably 20 or more, and more preferably 30 or more, from the viewpoint of preventing mottles or improving image quality in the image formation step by the electrophotographic recording process. A microformation index of less than 20 may cause uneven penetration of toners to the paper during thermal fusion of toners by the electrophotographic recording process, generating cloudy patches (mottles) and damaging the image quality.

Here, the microformation index is a value determined by using a 3D sheet analyzer (trade name: M/K950, manufactured by M/K Systems, Inc.) with an aperture of 1.5 mm in diameter and by analyzing with the Microformation Tester (MFT) (trade name, manufactured by M/K Systems, Inc.). Namely, a sample is placed on the rotating drum in the 3D sheet analyzer, and the local variation in basis weight of the sample is determined as variation in light intensity, by using a light source connected to the shaft of drum and a photodetector which is placed at a place corresponding to the light source outside the drum. The area to be analyzed during measurement is controlled by the diameter of the aperture fused at the inlet portion of the photodetector. Subsequently, the variations in light intensity (deviation) are amplified, A/D-converted, and classified into 64 optically determined basis-weight groups. A million pieces of data are collected by a single scan and are used for providing the histogram frequency for each group. The microformation index is a value calculated by dividing the maximum frequency (peak value) in the histogram by the number of the groups having a frequency of 100 or more among the 64 groups classified according to the respective slightly different basis weights and further multiplying the resulting value by 1/100. The greater the microformation index is, the better the microformation is.

If the recording paper according to the invention is used not only for ink jet recording but also for electrophotography or thermal transfer printing, or as a medium whereon images are recorded combinedly by these methods, it is preferable to adjust the surface electric resistance of the recording paper by adding an electrically conductive agent. However, it is desirable to use a non-halogen conductive agent, for the purpose of reducing the halogen content of the recording paper. Examples of these conductive agents include inorganic electrolytes such as sodium sulfate, sodium carbonate, lithium carbonate, sodium metasilicate, sodium tripolyphosphate, and sodium metaphosphate; anionic surfactants such sulfonate salts, sulfate salts, carboxylate salts, and phosphate salts; nonionic surfactants such as cationic surfactants, polyethylene glycol, glycerin, and sorbit; amphoteric surfactants, polymer electrolytes, and the like.

The recording paper according to the invention has an electrical surface resistance of at least one face thereof to be printed (printing face) in a range of about 1.0×10⁹ to 1.0×10¹¹ Ω/ [symbol] , more preferably in a range of about 5.0×10⁹ to 7.0×10¹⁰ Ω/ [symbol] , and still more preferably in a range of about 5.0×10⁹ to 2.0×10¹⁰ Ω/ [symbol] .

In addition, the volume electric resistance of the recording paper according to the invention is preferably in a range of about 1.0×10¹⁰ to 1.0×10¹² Ω·cm, more preferably in a range of about 1.3×10¹⁰ to 1.6×10¹¹ Ω·cm, and still more preferably in a range of about 1.3×10¹⁰ to 4.3×10¹⁰ Ω·cm.

The recording paper according to the invention may be used as a paper for image recording methods and devices by the ink jet or electrophotographic process.

Ink Jet Recording Method

Hereinafter, the ink jet recording method according to the invention will be described. The ink jet recording method according to the invention is not particularly limited if an ink is ejected onto the recording paper according to the invention for recording images (printing), and the ink used is also not particularly limited if it is an ink known in the art, and specific examples thereof include an ink containing at least a dye, inks containing at least a hydrophilic colorant and a water-soluble polymer containing both hydrophobic and hydrophilic portions, and the like. Here, the hydrophilic colorant means a dye and/or a pigment, and examples of the pigments include not only hydrophobic pigments dispersed in an ink combinedly with a pigment dispersing agent having a hydrophilic group, but also self-dispersing pigments, which will be described below. Solvents for the inks include water and water-soluble organic solvents known in the art, and the inks may additionally contain various additives and the like such as surfactants if necessary.

The inks used for the ink jet recording method according to the invention are preferably the water-soluble inks described above. Examples of ink sets used for multi-color printing may be ink sets including at least black, cyan, magenta, and yellow inks, and the respective inks are prepared by blending water, a water-soluble organic solvent, a colorant, a surfactant, a water-soluble polymer, and the like.

Each ink contains water, a water-soluble organic solvent, a colorant, surfactant, and a water-soluble polymer if necessary, and if a pigment is used as the colorant, the pigment is preferably a self-dispersing pigment (pigment soluble in water without addition of a pigment dispersing agent). The self-dispersing pigment is a pigment containing many water-solubilizing groups on the surface thereof, which can be dispersed consistently in an ink even in the absence of a pigment dispersing agent.

The above “self-dispersing pigment” specifically satisfies the following requirement. A pigment is first dispersed in water at a pigment concentration of 5% by weight with respect to 95% by weight of water without addition of a pigment dispersing agent, by using a dispersing machine such as a ultrasonic homogenizer, nanomizer, microfluidizer, ball mill, or the like. The dispersion, wherein the pigment is dispersed, is then placed in a glass bottle. After allowing the dispersion to stand for a day, the pigment concentration in the supernatant should not be less than 98% of the initial concentration. The method for determining the pigment concentration is not particularly limited and may be a method of determining the amount of solid matters after the sample is dried or of determining the pigment concentration from the light transmittance of a suitably diluted sample. Alternatively, any other method may be used if it can determine the pigment concentration correctly.

The above “self-dispersing pigments” may be produced by subjecting a common pigment to a surface modification treatment, such as an acid-base treatment, coupling agent treatment, polymer-grafting treatment, plasma treatment, oxidation/reduction treatment, or the like. The pigments subjected to such a surface treatment contain more water-solubilizing groups than the common pigments, and can be dispersed in ink without use of a pigment dispersing agent.

Common pigments to be subjected to such a surface modification treatment include Raven 7000, Raven 5750, Raven 5250, Raven 5000 ULTRA II, Raven 3500, Raven 2000, Raven 1500, Raven 1250, Raven 1200, Raven 1190 ULTRA II, Raven 1170, Raven 1255, Raven 1080, and Raven 1060 (heretofore, all are trade names, manufactured by Columbian D Carbon); REGAL® 400R, REGAL® 330R, REGAL® 660R, MOGUL® L, BLACK PEARLS® L, MONARCH® 700, MONARCH® 800, MONARCH® 880, MONARCH® 900, MONARCH® 1000, MONARCH® 1100, MONARCH® 1300, and MONARCH® 1400 (heretofore, all are trade names, manufactured by Cabot Corporation); Color Black FW1, Color Black FW2, Color Black FW2V, Color Black 18, Color Black FW200, Color Black S150, Color Black S160, Color Black S170, Printex® 35, Printex® U, Printex® V, Printex® 140U, Printex® 140V, Special Black 6, Special Black 5, Special Black 4A, and Special Black 4 (heretofore, all are trade names, manufactured by Degussa); No. 25, No. 33, No. 40, No. 47, No. 52, No. 900, No. 2300, MCF-88, MA600, MA7, MA8, and MA100 (heretofore, all are trade names, manufactured by Mitsubishi Chemical Co., Ltd.); C.I. Pigment Blue-1, C.I. Pigment Blue-2, C.I. Pigment Blue-3, C.I. Pigment Blue-15, C.I. Pigment Blue-15:1, C.I. Pigment Blue-15:3, C.I. Pigment Blue-15:34, C.I. Pigment Blue-16, C.I. Pigment Blue-22, C.I. Pigment Blue-60, C.I. Pigment Red 5, C.I. Pigment Red 7, C.I. Pigment Red 12, C.I. Pigment Red 48, C.I. Pigment Red 48:1, C.I. Pigment Red 57, C.I. Pigment Red 112, C.I. Pigment Red 122, C.I. Pigment Red 123, C.I. Pigment Red 146, C.I. Pigment Red 168, C.I. Pigment Red 184, C.I. Pigment Red-202, C.I. Pigment Yellow-1, C.I. Pigment Yellow-2, C.I. Pigment Yellow-3, C.I. Pigment Yellow-12, C.I. Pigment Yellow-13, C.I. Pigment Yellow-14, C.I. Pigment Yellow-16, C.I. Pigment Yellow-17, C.I. Pigment Yellow-73, C.I. Pigment Yellow-74, C.I. Pigment Yellow-75, C.I. Pigment Yellow-83, C.I. Pigment Yellow-93, C.I. Pigment Yellow-95, C.I. Pigment Yellow-97, C.I. Pigment Yellow-98, C. I. Pigment Yellow-114, C.I. Pigment Yellow-128, C.I. Pigment Yellow-129, C.I. Pigment Yellow-151, and C.I. Pigment Yellow-154; and the like, but are not limited thereto. Alternatively, magnetic fine particle such as magnetite and ferrite, or titan black may also be used.

In addition, commercially available “self-dispersing pigments” may also be used per se. Examples of these commercially available pigments include CAB-O-JET® 200, CAB-O-JET® 300, IJX-55 (trade name), IJX-164 (trade name), IJX-253 (trade name), IJX-266 (trade name), and IJX-273 (trade name) (heretofore, manufactured by Cabot Corporation); Microjet Black CW-1 (trade name) manufactured by Orient Chemical Industries, Ltd.; pigments sold from Nippon Shokubai Co., Ltd.; and the like.

The water-solubilizing group in the “self-dispersing pigment” may be either a nonionic, cationic, or anionic group, but is preferably a sulfone, carboxyl, hydroxyl, phosphate, or other group. If contained, the sulfate, carboxyl, or phosphate group may be used as a free acid or salt. If the acid forms a salt, preferably the counter ion of the acid is generally Li, Na, K, NH₄ or an organic amine.

The content of the pigment in ink with respect to total ink mass is preferably in a range of about 0.1 to 15% by mass, more preferably in a range of about 0.5 to 10% by mass, and still more preferably in a range of about 1.0 to 8.0% by mass. A pigment content of over 15% by mass often leads to clogging at the nozzle tips of print heads, while a pigment content of less than 0.1% by mass may not provide a sufficient image density.

It is preferable to use a purified product as the pigment. The impurities therein may be removed, for example, by rinsing with water, membrane ultrafiltration, ion-exchange treatment, adsorption with activated carbon, zeolite or the like. The purification method is not particularly limited, but the concentration of the inorganic matters derived from impurities of the colorants in ink is preferably 500 ppm or less and more preferably 300 ppm or less.

When a water-soluble colorant, i.e., a dye, is used as the colorant, any one of dyes known in the art or newly prepared may be used. Among them, direct or acid dyes are preferable, as they provide brilliant colors. Specific examples of the dyes include blue dyes such as C.I. Direct blue-1, -2, -6, -8, -22, -34, -70, -71, -76, -78, -86, -142, -199, -200, -201, -202, -203, -207, -218, -236 and -287, and C.I. Acid Blue-1, -7, -9, -15, -22, -23, -27, -29, -40, -43, -55, -59, -62, -78, -80, -81, -90, -102, -104, -111, -185 and -254;

red dyes such as C.I. Direct Red-1, -2, -4, -8, -9, -11, -13, -1, -20, -28, -31, -33, -37, -39, -51, -59, -62, -63, -73, -75, -80, -81, -83, -87, -90, -94, -95, -99, -101, -110 and -189, and C.I. Acid Red-1, -4, -8, -13, -14, -15, -18, -21, -26, -35, -37, -249 and -257; and

yellow dyes such as C.I. Direct Yellow-1, -2, -4, -8, -11, -12, -26, -27, -28, -33, -34, -41, -44, -48, -86, -87, -88, -135, -142 and -144, and C.I. Acid Yellow-1, -3, -7, -11, -12, -13, -14, -19, -23, -25, -34, -38, -41, -42, -44, -53, -55, -61, -71, -76 and -79. These dyes may be used alone or as a mixture of two or more dyes.

In addition to direct or acid dyes, a cationic dye may also be used, and examples thereof include: C.I. Basic Yellow-1, -11, -13, -19, -25, -33, and -36; C.I. Basic Red-1, -2, -9, -12, -13, -38, -39, and -92; C.I. Basic Blue-1, -3, -5, -9, -19, -24, -25, -26, and -28.

The total content of these dyes is 0.1% by mass or more and 10% by mass or less, preferably 0.5% by mass or more and 8% by mass or less, and more preferably 0.8% by mass or more and 6% by mass or less with respect to the ink mass. A content of more than 10% by mass leads to clogging at print head tips, while a content of less than 0.1% by mass cannot provide sufficient image quality.

Any known solvents may be used as the water-soluble organic solvent. Examples of the solvents include: polyvalent alcohols such as ethylene glycol, diethylene glycol, propylene glycol, polypropylene glycol, butylene glycol, triethylene glycol, 1,5-pentanediol, 1,2,6-hexanetriol, and glycerin; polyvalent alcohol ethers such as ethylene glycol monomethylether, ethylene glycol monoethylether, ethylene glycol monobutylether, diethylene glycol monomethylether, diethylene glycol monoethylether, diethylene glycol monobutylether, propylene glycol monobutylether, and dipropylene glycol monobutylether; nitrogen-containing solvents such as pyrrolidone, N-methyl-2-pyrrolidone, cyclohexylpyrrolidone, and triethanolamine; monovalent alcohols such as ethanol, isopropylalcohol, butylalcohol, and benzylalcohol: sulfur-containing solvents such as thiodiethanol, thiodiglycerol, sulfolane, and dimethylsulfoxide; propylene carbonate, ethylene carbonate, and the like.

The surfactant described above is added for the purpose of adjusting the surface tension of ink. Nonionic and anionic surfactants are desirable as the surfactant, as they barely affect the dispersion condition of pigments. Examples of the nonionic surfactants include polyoxyethylene nonylphenylether, polyoxyethylene octylphenylether, polyoxyethylene dodecylphenylether, polyoxyethylene alkylethers, polyoxyethylene fatty acid esters, sorbitan fatty acid esters, polyoxyethylene sorbitan fatty acid esters, fatty acid alkylol amides, acetylene alcohol ethyleneoxide adducts, polyethylene glycol polypropylene glycol block copolymers, polyoxyethylene ethers of glycerin esters, polyoxyethylene ethers of sorbitol esters, and the like.

Examples of the anionic surfactants include: alkylbenzenesulfonate salts, alkylphenylsulfonate salts, alkylnaphthalenesulfonate salts, higher fatty acid salts, sulfate and sulfonate salts of higher fatty esters, higher alkyl sulfosuccinate salts, and the like.

Further, examples of the amphoteric surfactants are betaines, sulfobetaines, sulfatobetaines, imidazoline, and the like. In addition to the above surfactants, silicone surfactants such as polysiloxane polyoxyethylene adducts, fluorinated surfactants such as oxyethylene perfluoroalkylethers, biosurfactants such as spiculisporic acid, rhamnolipids, lysolecithins, and the like may also be used.

Further, examples of the water-soluble polymers added if necessary to the ink include alginate salts, acrylate salts, carboxymethylcellulose sodium, and the like, but among them, preferable are copolymers from a monomer having an α,β-ethylene unsaturated group forming the hydrophilic portion thereof and a monomer having an α,β-ethylene unsaturated group forming the hydrophobic portion thereof. More preferably, the monomer forming the hydrophilic portion is at least a compound selected from the group consisting of acrylic acid, methacrylic acid, maleic anhydride, and maleic acid, while the monomer forming the hydrophobic portion, at least one compound selected from the group consisting of styrene acrylic acid and alkyl, aryl and alkylaryl esters of styrene methacrylic acid.

The molecular weight of the water-soluble polymer is in a range of about 3,000 to 15,000, preferably 4,000 to 10,000, and more preferably in a range of about 4,000 to 7,000, as the weight-average molecular weight determined by gel permeation chromatography (GPC).

The monomer having an α,β-ethylene unsaturated group forming the hydrophilic portion is not particularly limited, but examples thereof include monomers having a carboxyl or sulfone group such as acrylic acid, methacrylic acid, crotonic acid, itaconic acid, itaconic acid monoesters, maleic acid, maleic monoesters, fumaric acid, fumaric monoesters, vinylsulfonic acid, styrenesulfonic acid, and sulfonated vinylnaphthalenes, and the like. Among them, acrylic acid, methacrylic acid, maleic acid, and maleic anhydride are particularly desirable, and these monomers may be used alone or as a mixture of two or more monomers.

The monomer having an α,β-ethylene unsaturated group forming the hydrophobic portion is not particularly limited, but favorable examples thereof include styrene derivatives such as styrene, α-methylstyrene, and vinyltoluene; vinylnaphthalene, vinylnaphthalene derivatives, acrylic alkylesters, methacrylic alkylesters, crotonic alkylesters, itaconic dialkylesters, and maleic dialkylesters, and particularly preferable examples thereof are styrene, alkyl methacrylates, and alkyl, aryl and alkylaryl acrylates. These monomers may be used alone or in combination of two or more monomers.

It is effective to add any one of methylcellulose, ethylcellulose and the derivatives thereof, glycerins, polyglycerins and the polyethyleneoxide or polypropyleneoxide adducts thereof, and polysaccharides and the derivatives thereof as a viscosity adjuster. Specific examples of the viscosity adjusters include glucose, fructose, mannitol, D-sorbit, dextran, xanthan gum, curdlan, cycloamylose, maltitol and the derivatives thereof.

The viscosity of the ink used by the ink jet recording method according to the invention is preferably in a range of about 1.5 to 5.0 mPa·s, and more preferably in a range of about 1.5 to 4.0 mPa·s. The viscosity of the ink is determined by using a rotational viscometer Rheomat 115 (manufactured by Contraves), under the condition of a measurement temperature of 23° C. and a shear rate of 1,400 s⁻¹.

In addition, the pH of the ink may be adjusted to any desirable pH, and the pH adjusters include potassium hydroxide, sodium hydroxide, lithium hydroxide, ammonium hydroxide, triethanolamine, diethanolamine, ethanolamine, 2-amino-2-methyl-1-propanol, ammonia, ammonium phosphate, potassium phosphate, sodium phosphate, lithium phosphate, sodium sulfate, acetate salts, lactate salts, benzoate salts, acetic acid, hydrochloric acid, nitric acid, sulfuric acid, phosphoric acid, propionic acid, p-toluenesulfonic acid, and the like. Alternatively, common pH buffer agents, such as Good buffers, may be used.

The pH of the ink is preferably in a range of about 3 to 11, and particularly preferably in a range of about 4.5 to 9.5.

The surface tension of the ink may be adjusted mainly by controlling the addition amount of the surfactant above, and is preferably in a range of about 20 to 37 mN/m, and more preferably in a range of about 25 to 37 mN/m. A surface tension of less than 20 mN/m leads to excessive ink penetration into the recording paper, sometimes raising the density of the images formed on the back face by penetration and thus decreasing the double-face printability. A surface tension of greater than 37 mN/m slows down the ink penetration into recording paper, consequently leading to decrease in drying speed and thus in productivity to an extent not suitable for high-speed printing.

The surface tension of ink is determined under an environment of 23° C. and 55% RH by using an Wilhelmy surface tension balance.

For adjustment of the surface tension of ink, for example, at least one compound selected from surfactants, polyvalent alcohols, and monovalent alcohols may be added. If a surfactant is to be added, it is preferable to select at least one surfactant from nonionic and anionic surfactants. Additionally, the total content of the compounds above in ink is preferably in a range of about 0.01 to 3.0% by mass, more preferably in a range of about 0.03 to 2.0% by mass, and still more preferably in a range of about 0.05 to 1.5% by mass. In particular, if a single surfactant is used, the content thereof is preferably in a range of about 0.3 to 1.5% by mass.

If a compound having an ether bond is used as the monovalent alcohol, at least one compound represented by the following formula (3) is used as the compound. The content thereof in ink is preferably in a range of about 1 to 5% by mass, more preferably in a range of about 2 to 10% by mass, and still more preferably in a range of about 3 to 8% by mass.

CₙH₂ₙ₊₁(CH₂CRHO)ₘH Formula (3)

In Formula (3), n is an integer of 1 to 6; m, an integer of 1 to 3; and R, a hydrogen atom or an alkyl group having 1 to 5 carbon atoms.

If a compound other than the monovalent alcohol represented by the Formula (3) is used, the compound is preferably ethanol, propanol, butanol, or the like. The total content of the monovalent alcohols in ink is preferably in a range of about 1.0 to 8.0% by mass, and more preferably in a range of about 2.0 to 5.0% by mass. In addition, the surfactant, polyvalent alcohol, and monovalent alcohol described above may be added together at the same time.

If the ink used for the ink jet recording method according to the invention is an ink containing a pigment, such an ink may be prepared, for example, by adding a predetermined amount of the pigment above to an aqueous solution containing a pigment dispersing agent at a predetermined amount; after sufficient stirring, dispersing the mixture by using a dispersing machine; removing the coarse particles therein by means of centrifugation or the like; adding predetermined above water-soluble organic solvent, additives, and the like; and mixing and subsequently filtering the resulting mixture. A dense dispersion of pigments may be prepared in advance and used as diluted during the preparation of ink. A step for pulverizing the pigments may be additionally placed before the dispersing step. Alternatively, a pigment may be added to a pre-mixed solution containing a predetermined water-soluble organic solvent, water, and a pigment dispersing agent, and the resulting mixture may be dispersed by a dispersing machine.

Any commercially available machine may be used as the dispersing machine. Examples thereof include colloid mill, flow jet mill, Thrasher mill, high-speed disperser, ball mill, attriter, sand mill, sand grinder, ultrafine mill, Eiger motor mill, DYNO®-MILL (manufactured by Shinmaru Enterprise Co.), pearl mill, agitator mill, Covol mill, 3-roll mill, 2-roll mill, extruder, kneader, microfluidizer, laboratory homogenizer, ultrasonic homogenizer, and the like, and these machines may be used alone or in combination of two or more. For prevention of contamination by inorganic impurities, it is preferable to adopt a dispersion method that do not require a dispersion medium, and use of a microfluidizer, an ultrasonic homogenizer, or the like is preferable in such a case. Meanwhile, an ultrasonic homogenizer was used for dispersion in the Examples of the invention.

On the other hand, inks containing a self-dispersing pigment as the colorant (pigment) may be prepared, for example, by: subjecting the pigment to a surface modification treatment; adding the surfaced-treated pigment into water: after mixing the mixture well, dispersing the mixture if necessary by a dispersing machine similar to that described above; removing the coarse particles therein by means of centrifugation or the like; adding a predetermined solvent, additives and the like; and subsequently stirring, mixing, and filtering the resulting solution.

When the recording paper according to the invention is printed with the ink described above by the ink jet process, the amount of ink droplet ejected from nozzles is preferably in a range of about 1 to 20 pl, and more preferably in a range of about 3 to 18 pl.

When the amount of ink droplet is adjusted to a range of 1 to 20 pl, more preferably in a range of about 3 to 18 pl, during printing by the so-called thermal ink jet process, wherein the ink droplet is formed by the action of thermal energy, the diameter of dispersed pigment particles in ink is preferably in a range of about 20 to 120 nm as a volume average particle diameter, and the number of coarse particles having a diameter of 500 nm or more, 5×10⁵ or less in 2 pl of the ink. A volume average particle diameter of less than 20 nm occasionally leads to insufficient image density. Further, a volume average particle diameter of over 120 nm leads occasionally to clogging at print heads and thus to unstable ejection of ink. Furthermore, when the number of the coarse particles having a volume average particle diameter of 500 nm or more is more than 5×10⁵ in 2 μl of ink, clogging in the print heads may easily occur in the similar manner, frequently resulting in unstable ejection of ink. The number of coarse particles is more preferably 3×10⁵ or less, and more preferably, 2×10⁵ or less.

In addition, the storage elasticity of ink at 24° C. is particularly preferably in a range of about 5×10⁻⁴ to 1×10⁻² Pa. It is because inks having a suitable elasticity in this region allow favorable printing on the surface of recording papers. The storage elasticity is a value determined under a low-shear rate, i.e., at an angular rate in a range of about 1 to 10 rad/s. The value may be easily determined by using an analyzer that allows measurement of viscoelasticity in the low-shear rate region. Such analyzers include, for example, the VE-type viscoelasticity analyzer (manufactured by VILASTIC SCIENTIFIC INC.) and the DCR extremely-low-viscosity viscoelasticity analyzer (manufactured by Paar Physica), and the like.

The ink jet recording method according to the invention provides favorable printing quality by any ink jet recording system, if the method is used in the ink jet devices known in the art. The ink jet recording method according to the invention may be applied to the process wherein a heating means for heating recording paper before, during, or after printing is provided and the recording paper and ink are heated at a temperature of 50° C. to 200° C. for acceleration of adsorption and adhesion-fusing of the ink.

Hereinafter, an example of the ink jet recording device suitable for carrying out the ink jet recording method according to the invention will be described. The device is a so-called multi-path system, wherein images are formed by multiple scans of the recording head over the recording paper surface.

A specific example of the process ejecting an ink form the recording head (nozzle) is a so-called thermal ink jet process, wherein the ink in the nozzle is ejected by the pressure caused by foaming of the ink in the nozzle induced by application of electricity to a heater located inside the nozzle. Another example thereof is a process wherein the ink is ejected by the force generated by physical deformation of the nozzles caused by application of electricity to a piezoelectric device. Typically, such a process uses a piezoelectric element for the piezoelectric device. In the ink jet recording device used for the ink jet recording method according to the invention, the method of ejecting ink from nozzle is any of the above two process and is not limited to these process. The same shall apply hereinafter in this respect.

Recording heads (nozzles) are placed in the direction almost orthogonal to the main scanning direction of the head carriage. Specifically, the recording heads are, placed in line at a density of 800 pieces per inch. The number and density of the nozzles are arbitrary. In addition, the heads may be placed in a zigzag arrangement, instead of in line.

Ink tanks containing respectively cyan, magenta, yellow and black inks are connected integrally to the upper portion of the respective recording heads. The inks contained in the ink tanks are supplied to the recording heads corresponding to the respective colors. The ink tanks and the heads may not be formed integrally. However, in addition to this process, any other process, wherein for example, the ink tanks and the recording heads may be placed separately and the inks may be supplied to the recording heads via ink-supply tubes, may also be used.

Additionally, a signal cable is connected to each of these recording heads. The signal cables transmit the image information processed in the pixel processing unit concerning respective cyan, magenta, yellow and black colors, to respective recording heads.

The recording heads above are connected to the head carriage. The head carriage is mounted in such a manner that it can slide freely along the guide rod and the carriage guide in the main scanning direction. The head carriage is driven reciprocally via a timing belt along the main scanning direction by activation of a drive motor at predetermined timing.

A platen is connected to the lower portion of the head carriage, and a recording paper is supplied at predetermined timing onto the platen by a conveying roller for paper feed. The platen may be, for example, prepared from a plastic molding material or the like.

In this way, the inks described above may be used for printing images on the recording paper according to the invention. A multi-path system equipped with four pieces of heads is described above as an example. However, the multi-path systems, to which the ink jet recording method according to the invention is applicable, are not limited to this example. A system equipped with two (black and color) heads, wherein the color head is divided into multiple separate compartments for storing predetermined different color inks, from which the inks are supplied to multiple nozzles placed along the color head, may also be used.

In the so-called multi-path system wherein a print head travels in the direction orthogonal to the recording-paper feed direction, printing-head scanning speed is the speed of a moving recording head, when the recording head scans and prints multiple times on the surface of recording paper.

For high-speed printing at a printing speed of 10 ppm (10 sheet/minute) or more, equivalent to that of laser printers available in many offices, the scanning speed of the print head should be not less than 25 cm/sec, which leads to a shorter ink-ejection pitch and greater paper deformation. It also demands use of inks having lower surface tension in order to improve drying speed of the inks, and the use of such inks, in turn, expands the area of paper deformation and increases curl and cockle of printed papers, as the inks lower in surface tension are more permeable into papers.

Hereinafter, a second example of the ink jet recording device for carrying out the ink jet recording method according to the invention will be described. The device is called a one-path system, which has a recording head almost identical in length with the recording paper. In such a system, printing on a recording paper is completed once the paper-conveys under the head. The one-path systems provide a greater scanning speed and thus greater productivity than the multi-path systems, and allow high-speed printing faster than the laser recording process.

The one-path systems are compatible with a recording-paper feed speed (speed of a recording paper passing under the recording head) of 60 mm/sec or more, equivalent to 10 ppm or more, as they do not demand scanning of the recording head multiple times as in multi-path system, easily allowing high-speed printing. However, they also demand ejection of a large amount of ink at the same time, as they cannot print dividedly. Accordingly, conventional ink jet recording methods that do not employ the recording paper according to the invention increase paper deformation, causing irregular paper feed, the friction between the print head and recording paper, and the like, and thus leading to increase in deformation of the printed paper after printing and drying and decrease in document quality.

The scanning speed of the print head is preferably about 500 mm/sec or more, and more preferably about 1,000 mm/sec or more, from the viewpoint of providing a “productivity equivalent to that of laser printer”. Further, the recording-paper feed speed is preferably about 100 mm/sec or more, and more preferably about 210 mm/sec.

With respect to the ink jet recording method according to the invention, the maximum ink ejection is preferably in a range of about 6 to 30 ml/m².

The maximum ink ejection is an ink quantity ejected in one scan per unit area, when a closely overlapping image is formed by using one or more color ink.

In any one of the process above, the maximum ink ejection should be greater than about 6 ml/m², for ejecting an amount of ink sufficient to form a closely overlapping image in fewer scan number. However, even in high-speed printing which demands such a large ink ejection, use of the ink jet recording method according to the invention provides documented papers without paper deformation such as curl and cockle, allowing favorable paper-conveying speed and printing quality comparable to that of laser printing process.

The maximum ink ejection is preferably in a range of about 7 to 20 ml/m², and more preferably in a range of about 10 to 18 ml/m².

As described above, the ink jet recording method according to the invention allows production of documents fewer in paper deformation, favorable in paper-conveying speed, and higher in quality, even in an ink jet recording device that prints rapidly at a printing speed of about 10 ppm or more.

Hereinafter, an embodiment of the ink jet recording device according to the invention will be described in detail with reference to Figs. In the Figs., the same code is designated to the same or corresponding parts to eliminate duplicated explanation.

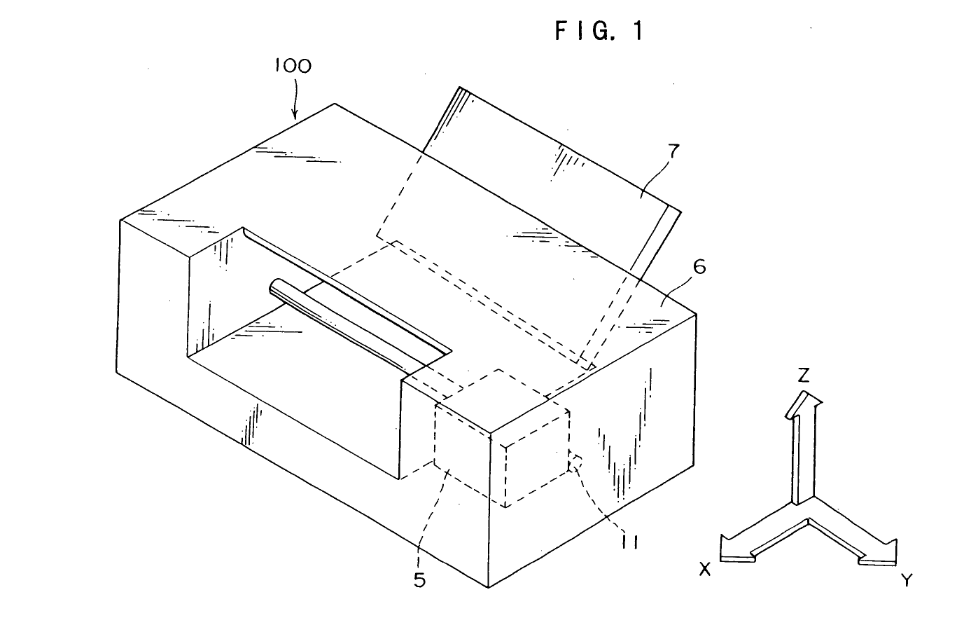

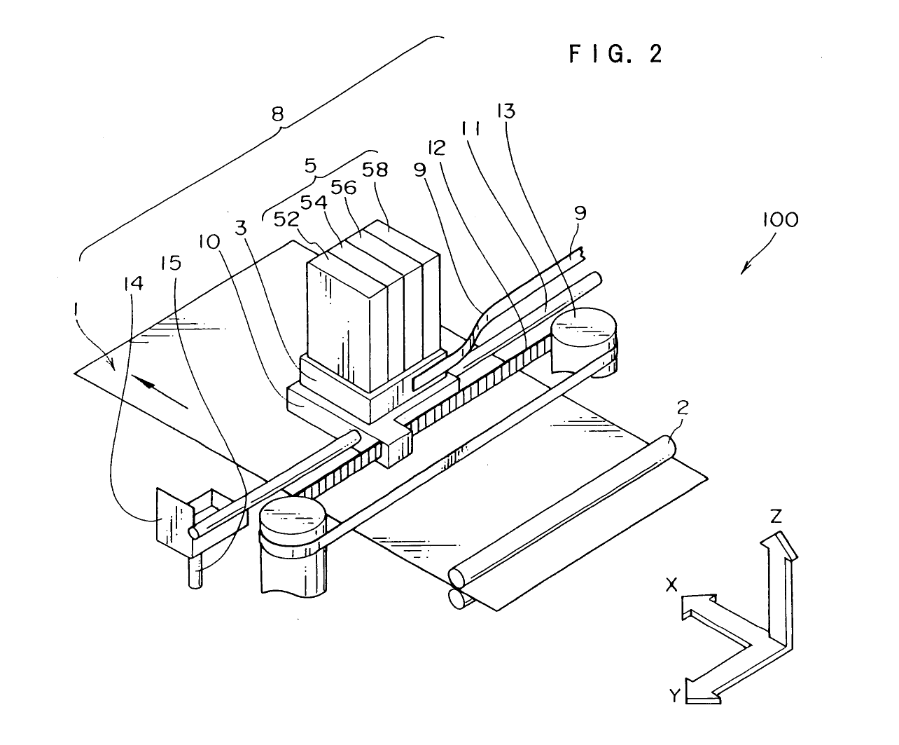

FIG. 1 is a perspective view illustrating an apparent configuration of an embodiment of the ink jet recording device according to the invention. FIG. 2 is a perspective view illustrating an internal basic configuration of the ink jet recording device shown in FIG. 1. An ink jet recording device 100 according to this embodiment has a configuration that allows operation and image formation according to the ink jet recording method according to the invention. As illustrated in FIGS. 1 and 2, the ink jet recording device 100 mainly consists of an external cover 6, a tray 7 on which a predetermined amount of recording papers 1 such as regular papers and the like, conveying rollers (conveying means) 2 for conveying the recording paper 1 one by one into the ink jet recording device 100, and an image recording unit 8 (image recording means) for ejecting inks onto the face of the recording paper 1 and forming images.

The conveying rollers 2, a pair of rotatable rollers installed inside the ink jet recording device 100, pick up a recording paper 1 placed on the tray 7, and convey a predetermined amount of the recording papers 1 one by one at a predetermined timing into the device 100.

The image recording unit 8 forms images using inks on the face of the recording paper 1. The image recording unit 8 consists mainly of a recording head 3, an ink tanks unit 5, a power-supply and signal cable 9, a carriage 10, a guide rod 11, a timing belt 12, drive pulleys 13, and a maintenance unit 14.

The ink tank unit 5 has ink tanks 52, 54, 56, and 58 containing ejection inks respectively different in color. Here, the recording head 3 and the ink tank unit 5 consist respectively of a black-ink recording head for ejecting (spraying) a black ink and ink tank for black ink, and of color-ink recording heads for ejecting (spraying) color inks and ink tanks for color inks.

Further, as illustrated in FIG. 2, the power-supply and signal cable 9 and the ink tank unit 5 are connected to the recording head 3, and if external image recording information is input to the recording head 3 via the power-supply and signal cable 9, a recording head 3 absorbs a predetermined amount of ink from an ink tank and ejects the ink onto the face of recording paper according to the image recording information. The power-supply and signal cable 9 has a role of supplying the power necessary to drive the recording head 3, in addition to supplying the image recording information above.

The carriage 10 and the recording heads 3 located thereon are connected to a guide rod 11 and a timing belt 12 that is connected to drive pulleys 13. In this configuration, the recording head 3 is movable in parallel to the face of the powder-dusted recording paper 1 along the guide rod 11, and in the direction Y (main scanning direction) orthogonal to the traveling direction X of the recording paper 1 (sub-scanning direction). The carriage 10 carrying the recording heads 3 moves along the guide rod 11, by the driving force transmitted via the timing belt 12 from the drive pulleys 13 that rotate at a predetermined timing according to the image recording information, namely, the carriage 10 moves reciprocally in the direction Y (main scanning direction) orthogonal to the traveling direction X of the recording paper 1 (sub-scanning direction), forming images at a particular predetermined on the face of the recording paper 1.

The ink jet recording device 100 is equipped with a control means (not shown in the figure) for adjusting the timing of driving the recording heads 3 and the carriage 10 according to the image recording information. In this manner, images are continuously formed in a particular predetermined on the face of the recording paper 1, which is conveyed at a predetermined speed in the traveling direction X according to the image recording information.

The maintenance unit 14 is connected via a tube 15 to a pressure reducing device (not shown in the figure). Further, the maintenance unit 14 is connected to the nozzle portion of the recording heads 3, and has a role of absorbing inks from the nozzles of the recording heads 3 by reducing the pressure inside the nozzles of recording heads 3. The maintenance unit 14 thus installed allows removal of excessive ink adhered to the nozzles during operation of the ink jet recording device 100 if necessary, and suppression of vaporization of the inks from nozzles during the no operating period.

Electrophotographic Recording Method

The electrophotographic recording method according to the invention comprises: electrically charging a surface of an electrostatic latent image bearing body (electrophotographic photoreceptor), exposing the surface of the electrostatic latent image bearing body to light to form an electrostatic latent image thereon; developing the electrostatic latent image formed on the surface of the electrostatic latent image bearing body using an electrostatic image developer containing a toner to form a toner image; transferring the toner image, directly or via an intermediate transfer body, onto a surface of the recording paper; and fusing the toner image on the surface of the recording paper; and may further comprise, if desirable, other steps known in the art such as: cleaning to remove toner and foreign particles adhered on the electrostatic latent image bearing body; and discharging to eliminate the electrostatic latent images remaining on the surface of the electrostatic latent image bearing body.

The image recording device (electrophotographic recording device according to the invention) suitable for the electrophotographic recording method according to the invention comprises: a charging means that uniformly charges a surface of the electrostatic latent image bearing body (electrophotographic photoreceptor); an exposing unit that exposes the surface of the electrostatic latent image bearing body to light and forms an electrostatic latent image; a developing means that develops the electrostatic latent image formed on the surface of the electrostatic latent image bearing body using an electrostatic image developer and forms a toner image thereon; a transferring means that transfers the toner image, directly or via an intermediate transfer body, onto a surface of a recording paper; and a fusing means that fuses the toner image on the surface of the recording paper, and may further comprise, if desirable, other units known in the art such as: a cleaning unit that removes the toner and foreign particles adhered on the electrostatic latent image bearing body; and a discharging unit that eliminates the electrostatic latent images remaining on the surface of the electrostatic latent image bearing body.

Any one of electrostatic latent image bearing bodies know in the art may be used as the electrostatic latent image bearing body, and any one of known photosensitive layers, such as organic and amorphous silicon photosensitive layers and the like, as the photosensitive layer thereof. Cylindrical electrostatic latent image bearing bodies may be prepared by publicly know manufacturing processes, for example, by extruding aluminium or an aluminium alloy and refining the surface of the products. Alternatively, a belt-shaped electrostatic latent image bearing body may also be used.

The charging means are not particularly limited and includes, for example, electrostatic charging devices known in the art, such as contact-type chargers using conductive or semiconductive roll, brush, film, rubber blade, or the like; Scorotron chargers utilizing corona discharge; and Corotron chargers. Among them, contact-type electrostatic charging devices are preferable, as they are higher in charge compensation capacity. The above charging means applies direct current normally to the electrophotographic photoreceptor (electrostatic latent image bearing body), but alternate current may also be superimposed. The charging may be suitably performed by the charging means. For example, the electrophotographic photoreceptor is commonly charged to −300 to −1,000 V by the charging means.

The exposing means above are not particularly limited, and include, for example, optical devices that can expose desired images directly or via polygon millers on the surface of the electrophotographic photoreceptor, using the light from a light source such as semiconductor laser light, LED light, liquid crystal shutter light, or the like.

The developing means may be suitably selected depending on the purpose, but examples thereof include developing devices of developing images by applying a monocomponent or bicomponent developer directly or indirectly by brush, roll, or the like.

The transferring means include contact-type transferring devices that transfer toner images onto a recording paper by pressing a transfer roll or the like to the rear side of a semiconductive belt, and no contact-type transferring devices that transfer images on a recording paper by using Corotron or the like.

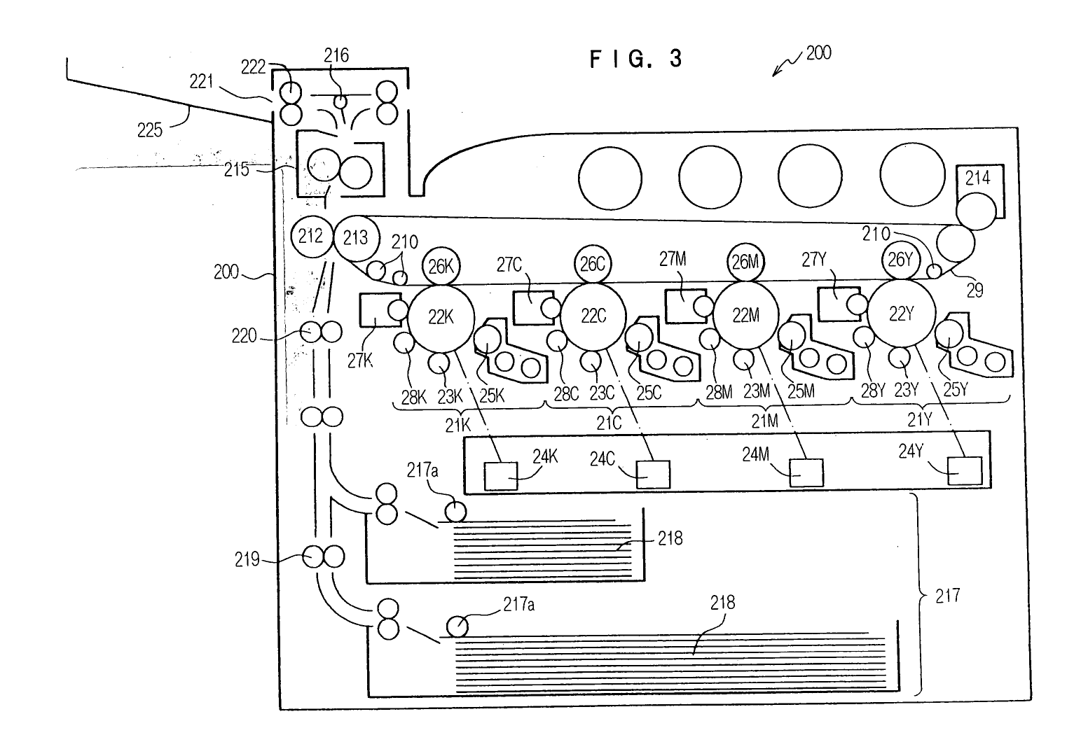

Hereinafter, an embodiment of the electrophotographic recording device according to the invention will be described in detail with reference to FIG. 3. In the Figure, the same code is designated to the same or corresponding parts to eliminate duplicated explanation.

FIG. 3 is a schematic diagram illustrating an embodiment of the electrophotographic recording device according to the invention. An image recording device 200 receives color image information supplied from a personal computer or the like not shown in the Figure, or color image information about color documents from an image data input device or an image scanner, and performs image processing of the input image information.

Parts 21Y, 21M, 21C, and 21K are electrophotographic image forming units forming respectively yellow, magenta, cyan, and black toner images, and these units are located serially in the order of 21Y, 21M, 21C, and 21K in the traveling direction of the endless intermediate transfer body 29 pulled by multiple extension rolls 210. The intermediate transfer body 29 travels between electrostatic latent image bearing bodies 22Y, 22M, 22C, and 22K respectively of the electrophotographic image forming units 21Y, 21M, 21C, and 21K, and the corresponding transferring means 26Y, 26M, 26C, and 26K.

The image forming operation onto the intermediate transfer body 29 will be described taking the electrophotographic image forming unit 21Y, which forms yellow toner images, as an example.

First, the surface of the electrostatic latent image bearing body 22Y is electrically charged evenly by a uniformly charging device 23Y. Subsequently, by exposure to light images corresponding to yellow images from a light emitting device 24Y, electrostatic latent images corresponding to the yellow image are formed on the surface of the electrostatic latent image bearing body 22Y. The electrostatic latent image corresponding to the yellow images are converted to yellow toner images by a developing device 25Y, which in turn is transferred onto the intermediate transfer body 29 by the pressure and electrostatic attraction of the first transfer roll 26Y, a constituent of the first transferring means. The yellow toner remaining after the transfer on the electrostatic latent image bearing body 22Y is removed by an electrostatic latent image bearing body cleaning device 27Y. The surface of the electrostatic latent image bearing body 22Y is discharged by a discharging device 28Y, and then recharged by the uniformly charging device 23Y once again for the next cycle of image formation.

In the image recording device 200 wherein multicolor images are formed, the image formation similar to that above is performed by the electrophotographic image forming units 21M, 21C, and 21K at timings reflecting the relative positions of the electrophotographic image forming units 21Y, 21M, 21C, and 21K, forming full color toner images on the intermediate transfer body 29.

The full color toner images formed on the intermediate transfer body 29 are transferred onto the recording paper 218 conveyed at a predetermined timing to the second transfer position, by the pressure and electrostatic attraction of a backup roll 213 supporting the intermediate transfer body 29 and the second transfer roll 212, a constituent of the second transferring means pressing the backup roll 213.

As shown in FIG. 3, recording papers 218 in a desirable size are supplied one by one from a paper feed cassette 217 (recording paper container) located at the bottom of the image recording device 200 by paper feed rolls 217a. The recording paper 218 are conveyed by multiple carrying rolls 219 and resist rolls 220 at a predetermined timing to the second transfer position in the intermediate transfer body 9. As described above, the full color toner images are transferred collectively onto the recording paper 218 from the intermediate transfer body 29 by the backup roll 213 and the second transfer roll 212 of the second transferring means.

The recording paper 218, onto which the full color toner images are transferred from the intermediate transfer body 29, is separated from the intermediate transfer body 29; conveyed to a fusing device 215 located downstream to the second transferring means, wherein the toner images are fused on the recording paper 218 by the heat and pressure of the fusing device 215; and discharged with its image-formed face above onto a delivery tray 225 by a delivery roll 222, after the traveling route is automatically switched to a delivery outlet 221 by a traveling direction-switching gate 216.

The remaining toner on the intermediate transfer body 29, which is not transferred onto the recording paper 218 by the second transferring means, is conveyed to the intermediate transfer body cleaning device 214 as it is adhered to the intermediate transfer body 29, and removed from the intermediate transfer body 29 by the cleaning means 214 and is reused for image formation.

### EXAMPLES

Hereinafter, the present invention will be described in more detail with reference to Examples, but it should be understood that the invention is not limited to these Examples.

First, recording papers, which will be used in the following Examples and Comparative Examples, are prepared by the following procedures.

Preparation of Recording Papers

Recording Paper 1

A hardwood Kraft pulp is bleached in an elemental chlorine free (ECF) multi-stage bleaching process consisting of the steps of oxygen bleaching, alkali extraction, and gas-phase chlorine dioxide treatment. The pulp thus obtained is beaten until the freeness of the pulp becomes 450 ml, and 3 parts by weight of a bentonite filler and 3 parts by weight of a light calcium carbonate filler, and 0.1 parts by weight alkyl of a ketene dimer (AKD) internal sizing agent with respect to 100 parts by weight of pulp are added to the pulp. The resulting mixture is sheeted. Separately, a coating solution containing 85 parts by weight of water, 10 parts by weight of N,N-bis(hydroxyethyl)-2-aminoethanesulfonic acid, 4 parts by weight of an oxidized starch (trade name: Ace A, manufactured by Oji Cornstarch Co., Ltd.) as a water-soluble resin, and 1 part by weight of sodium sulfate as a conductive agent is prepared as a surface sizing agent. The paper is size-pressed with the surface sizing agent, to provide a recording paper coated with N,N-bis(hydroxyethyl)-2-aminoethanesulfonic acid and oxidized starch respectively in amounts of 1.5 g/m² and 0.7 g/m².

For reference, the coating with a conductive agent is not required if the paper is used only for ink jet recording, and the same applies for the following recording papers prepared.

Recording Paper 2

A hardwood Kraft pulp is bleached in an ECF multi-stage bleaching process consisting the steps of xylanase treatment, alkali extraction, hydrogen peroxide treatment, and ozone treatment. The pulp thus obtained is beaten until the freeness thereof becomes 450 ml, and then 3 parts by weight of a kaolin filler, 6 parts by weight of a light calcium carbonate filler, and 0.2 part by weight of an alkenylsuccinic anhydride (ASA) internal sizing agent are added to the pulp with respect to 100 parts by weight of the pulp. The resulting mixture is sheeted. Separately, a coating solution containing 85 parts by weight of water, 5 parts by weight of cation-denatured polyvinylalcohol (trade name: Gosefimer, manufactured by Nippon Synthetic Chemical Industry Co., Ltd.) as a water-soluble resin, and 10 parts by weight of N,N-bis(hydroxyethyl)glycine is prepared as a surface sizing agent. The paper is size-pressed, to provide a recording paper coated with N,N-bis(hydroxyethyl)glycine and cation-denatured polyvinylalcohol respectively in amounts of 2.0 g/m² and 1.0 g/m².

Recording Paper 3

A softwood mechanical pulp is bleached with hydrosulfite, and beaten until the freeness thereof becomes 450 ml. Eight parts by weight of a light calcium carbonate filler, 0.02 parts by weight of an alkenylsuccinic anhydride (ASA) internal sizing agent are blended to the pulp with respect to 100 parts by weight of the pulp. The resulting mixture is sheeted. Separately, a coating solution containing 95 parts by weight of water, and 5 parts by weight of nonionic polyvinylalcohol (Poval 117, manufactured by Kuraray Co., Ltd.) is prepared as a water-soluble resin. The paper is size-pressed, to provide a recording paper coated with nonionic polyvinylalcohol in an amount of 1.0 g/m².

Recording Paper 4

A paper is prepared in the similar manner to Recording paper 1, except that a hardwood sulfite pulp is used. Separately, a coating solution containing 85 parts by weight of water, 20 parts by weight of N-methyldiethanolamine, 4 parts by weight of an oxidized starch (trade name: Ace A, manufacture by Oji Cornstarch Co., Ltd.) as a water-soluble resin, and 1 part by weight of sodium sulfate as a conductive agent is prepared as a surface sizing agent. The paper is size-pressed with the surface sizing agent, to provide a recording paper coated with N-methyl diethanolamine and the oxidized starch respectively in amounts of 1.5 g/m² and 0.7 g/m².

Preparation of Inks

Inks, which will be used in the following Examples and Comparative Examples, are prepared according to the following procedures.

Ink 1

In this ink, a water-soluble polymer, sodium salt of a styrene/methacrylic acid copolymer (monomer ratio: 50/50, weight-average molecular weight: 7,000), is used as the dispersant for dispersing pigments therein.

To a stirred mixture of 45 parts by weight of an aqueous solution of the water-soluble polymer (solid matter: 10% by weight) and 210 parts by weight of ion-exchange water, 45 parts by weight of carbon black (trade name: BPL, manufactured by CABOT) is added, and the resulting mixture is stirred for 30 minutes. Then, the mixture is dispersed by a microfluidizer under a condition at 10,000 psi and 30 paths. After dispersion, the dispersion is adjusted with 1N aqueous NaOH solution to pH 9, and further centrifuged (at 8,000 rpm for 15 minutes) by a centrifugal separator, and filtered through a 2-μm membrane filter. The dispersion thus obtained is diluted with demineralized water, to provide a pigment dispersion having solid matters at 10% by weight.

Ethylene glycol: 12 parts by weight

Ethanol: 4 parts by weight

Urea: 5 parts by weight

Sodium laurylsulfate: 0.1 part by weight

Subsequently, deionized water is added to the mixture having the composition above to a total amount of 50 parts by weight, and the mixture is stirred for 30 minutes. Then, 50 parts by weight of the pigment dispersion above is added to the mixture, and the resulting mixture is stirred for additional 30 minutes. The resulting mixture is filtered through a 2-μm membrane filter, to provide an ink 1. The surface tension of this ink is 35 mN/m, and the viscosity thereof 2.6 mPa·s. The storage elasticity thereof is 1.0×10⁻³ Pa at 24° C., and the number of coarse particles in ink 1 having a particle diameter of 500 nm or more, 11.2×10⁴.

Ink 2

A black colorant (trade name: CAB-O-JET® 300, manufactured by Cabot Corporation) is centrifuged (at 8,000 rpm for 40 minutes), to provide a pigment dispersion (pigment concentration: 14.4% by weight).

The pigment dispersion above: 35 parts by weight

Diethylene glycol: 18 parts by weight

Urea: 5 parts by weight

Then, deionized water is added to the mixture having the above composition to a total amount of 50 parts by weight, to which 50 parts by weight of the pigment dispersion above is added to a total amount of 100 parts by weight. 1N aqueous lithium hydroxide solution is added to the liquid, until the solution turns to be a pH of 8.0. The resulting liquid is stirred for 30 minutes and then filtered through a 2-μm membrane filter, to provide an ink 2. The surface tension of the ink is 33 mN/m, and the viscosity 2.1 mPa·s. The storage elasticity thereof is 5.0×10⁻³ Pa at 24° C., and the number of coarse particles in ink 1 having a particle diameter of 500 nm or more 18.6×10⁴.

Ink 3

A black colorant (trade name: CAB-O-JET® 300, manufactured by Cabot Corporation) is centrifuged (at 8,000 rpm for 40 minutes), to provide a pigment dispersion (pigment concentration: 14.4% by weight).

The pigment dispersion above: 35 parts by weight

Diethylene glycol: 20 parts by weight

Polyoxyethylene 2-ethylhexylether (trade name: Blaunon EH4, manufactured by Aoki Oil Industrial Co., Ltd.): 0.25 part by weight

Urea: 6 parts by weight

Isopropylalcohol: 2 parts by weight

Subsequently, deionized water is added to the mixture having the above composition to a total amount of 50 parts by weight, to which 50 parts by weight of the pigment dispersion is added to a total amount of 100 parts by weight. The resulting mixture is stirred for 30 minutes, and then filtered through a 2-μm membrane filter. The surface tension of this ink is 31 mN/m, and the viscosity 2.2 mPa·s. The storage elasticity thereof is 6.0×10⁻⁴ Pa at 24° C., and the number of coarse particles in ink 3 having a particle diameter of 500 nm or more 24.6×10⁴.

Ink 4

Dye (Direct Red 227, 10% aqueous solution): 20 parts by weight

Ethylene glycol: 25 parts by weight

Urea: 5 parts by weight

Surfactant (trade name: Surfynol 465, manufactured by Nissin Chemical Industry Co., Ltd.): 2 parts by weight

Deionized water is added to the mixture having the above composition to a total amount of 100 parts by weight, and the mixture is stirred for 30 minutes, and then filtered through a 1-μm membrane filter. The surface tension of this ink is 31 mN/m, and the viscosity 2.0 mPa·s. The storage elasticity thereof is 1.0×10⁻² Pa at 24° C.

### Example and Comparative Example

Printing tests of the recording papers and inks thus obtained are performed in an ink jet recording device, using the combinations thereof shown in Table 1, and the recording papers and the inks are evaluated. “No.” in the column of “paper” shown in Table 1 corresponds to the number of the recording paper in each Example or Comparative Example (e.g., recording paper 2 in Example 1). “No.” in the column of “ink” corresponds to the number of the inks used in each Example or Comparative Example.

The thermal ink jet recording device used for printing test is the WorkCentre B900 (trade name, manufactured by Fuji Xerox Co., Ltd.). The printing tests are conducted under an environment of 23° C. and 55% RH, using a multi-path-printing bench for evaluation equipped with 4 pieces of recording heads as the ink jet recording device. The printing device has 256 nozzles, a nozzle pitch of 800 dpi, a drop volume of about 15 pl, the maximum ink ejection of about 15 ml/m². The printing mode is one-face batch printing, and the head scan speed is about 450 mm/sec. Hereinafter, the methods used for evaluation of the inks will be described.

Evaluation of Physical Properties of Inks

The surface tension is determined under an environment of 23° C. and 55% RH using a Wilhelmy surface tension balance. A sample ink is placed in a measuring container by using a viscometer (trade name: Rheomat 115, manufactured by Contraves) according to a predetermined procedure, which is then mounted on the balance, and the surface tension is determined by the balance. The measurement temperature is 23° C., and the shear rate is 1,400 s⁻¹.

Evaluation of Ink-Drying Time

The evaluation of the ink-drying time is conducted by visually observing the ink transfer that is caused by pressing a paper on the image portion repeatedly from the time immediately after printing. The period until there is no ink transfer on the pressed paper is determined. Solid patch portions of image portion are used for analysis, and the ink-drying time is evaluated according to the following criteria.

A: 2 seconds or less.

B: 2 to 5 seconds.

C: 5 to 10 seconds.

D: 10 seconds or more.

Evaluation of the Curl Immediately After Printing

A closely overlapping 100%-monochromous image is printed on a postcard-sized recording paper having 5-mm margins. The amount of the hanging curl generated on the opposite face of printed face immediately after printing is determined. The measured values are converted to and evaluated by curvatures. The evaluation criteria are as follows, and A and B indicate that the corresponding inks are on the allowable level.

A: Less than 20 m⁻¹.

B: 20 m⁻¹ or more and less than 35 m⁻¹.

C: 35 m⁻¹ or more and less than 50 mm⁻¹.

D: 50 mm⁻¹ or more.

Evaluation of Cockle Immediately After Printing

A 2 cm×2 cm closely overlapping 100%-monochromous image is printed at the center of a postcard-sized recording paper, and the maximum altitude of the resulting wave generated immediately after printing is determined by a laser displacement meter. The evaluation criteria are as follows, and A and B indicate that the corresponding inks are on the allowable level.

A: Less than 1 mm.

B: 1 mm or more, and less than 2 mm.

C: 2 mm or more, and less than 3 mm.

D: 3 mm or more.

Evaluation of the Curl After Drying

A closely overlapping 100%-monochromous image is printed on a postcard-sized recording paper having 5-mm margins, and the paper is allowed to stand flat with the printed face facing upward under an environment of 23° C. and 50% RH for 100 hours after printing, and the amount of the hanging curl generated is determined. The measured values are converted to and evaluated by curl curvatures. The evaluation criteria are as follows, and A and B indicate that the corresponding inks are on the allowable level.

A: Less than 20 m⁻¹.

B: 20 m⁻¹ or more, and less than 35 m⁻¹.

C: 35 m⁻¹ or more, and less than 50 m⁻¹.

D: 50 m⁻¹ or more.

Evaluation of Image Quality Evaluation

The reflection density of the closely overlapping 100%-monochromous image prepared for evaluation of curl is determined after the printed paper is allowed to stand for 100 hours after printing. The image quality is analyzed by using the Diazo/Silver Film Densitometer (Model 369, manufactured by X-Rite Incorporated.). The evaluation criteria are as follows, and A and B indicate that the corresponding inks are on the allowable level.

A: 1.4 or more

B: 1.2 or more, and less than 1.4.

C: 1.0 or more, and less than 1.2.

D: Less than 1.0.

The results of various evaluations described above after conducting printing tests using the combinations of recording paper and ink shown above in Table 1 are summarized in Table 2.

TABLE 1

| | Paper | | | | | | Ink | | | | |
|---|---|---|---|---|---|---|---|---|---|---|---|
| | | | Application | Melting | | Micro- | | | | Surface | Water- |
| | | | amount | point | Smoothness | formation | | | Kind of | tension | soluble |
| | No. | Kind of compound | (g/m²) | (° C.) | (s) | index | No. | Color | colorant | (mN/m) | polymer |
| Example 1 | 2 | N,N- | 2 | 190 | 100 | 30 | 1 | Black | Pigment | 35 | Styrene/ |
| | | bis(hydroxyethyl)glycine | | | | | | | | | methacrylic |
| | | | | | | | | | | | acid |
| | | | | | | | | | | | copolymer |
| Example 2 | 1 | N,N-bis(hydroxyethyl)-2- | 1.5 | 154 | 60 | 40 | 2 | Black | Pigment | 33 | None |
| | | aminoethanesulfonic acid | | | | | | | | | |
| Example 3 | 1 | N,N-bis(hydroxyethyl)-2- | 1.5 | 154 | 60 | 40 | 4 | Magenta | Dye | 31 | None |
| | | aminoethanesulfonic acid | | | | | | | | | |
| Example 4 | 4 | N-Ethyldiethanolamine | 1.5 | −21 | 100 | 30 | 4 | Magenta | Dye | 31 | None |
| Comparative | 3 | None | 0 | — | 120 | 30 | 1 | Black | Pigment | 35 | Styrene/ |
| Example 1 | | | | | | | | | | | methacrylic |
| | | | | | | | | | | | acid |
| | | | | | | | | | | | copolymer |
| Comparative | 3 | None | 0 | — | 120 | 30 | 3 | Black | Pigment | 31 | None |
| Example 2 | | | | | | | | | | | |
| Comparative | 3 | None | 0 | — | 120 | 30 | 4 | Magenta | Dye | 31 | None |
| Example 3 | | | | | | | | | | | |

TABLE 2

| | Ink- | Curl | Cockle | Curl | Image |
|---|---|---|---|---|---|
| | drying | immediately | immediately | after | quality |
| | period | after printing | after printing | drying | density |
| Example 1 | B | B | B | A | A |
| Example 2 | A | A | B | A | B |
| Example 3 | A | A | B | B | A |
| Example 4 | A | B | B | B | B |
| Comparative | C | D | C | C | C |
| Example 1 | | | | | |
| Comparative | B | D | C | D | D |
| Example 2 | | | | | |
| Comparative | B | D | D | D | D |
| Example 3 | | | | | |

As apparent from Table 2, if printed by the ink jet recording method, use of the recording paper according to the invention containing the amine represented by the Formula (α), enables favorable paper-conveying and printing on both faces of recording paper, by suppressing generation of curl and cockle immediately after printing, and provides high-quality documented papers by suppressing generation of curl and cockle after a sheet is left out and dried.

In particular, the recording paper containing the amine represented by the Formula (2) above is also improved in image density.

### Example 5

After images are transferred, fused, and stored, using a color laser printer (trade name: DocuCentre Color 400cp, manufactured by Fuji Xerox Co., Ltd.) having a configuration similar to the image recording device shown in FIG. 3, and formed by the electrophotographic process, the curl immediately after printing evaluation, the cockle immediately after printing, and the curl after drying are examined, giving similar results. The results indicate that the use of the recording paper according to the invention is effective in preventing curl and cockle even in the image recording method by the electrophotographic process.

As described above, when images are printed by the ink jet recording system, the invention enables printing of the images on both faces of papers by suppressing generation of curl and cockle immediately after printing and at the same time suppresses curl and cockle after a sheet is left out and dried, and provides a recording paper usable for image formation by the electrophotographic process, and an image recording method and image recording device using the same, for example, by the ink jet or electrophotographic process.

What is claimed is:

1. A recording paper comprising pulp fiber, a filler, and an amine, wherein
the amine is a primary, secondary, or tertiary amine represented by the following Formula (α): 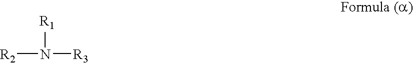
wherein at least one of substituents represented by R₁, R₂, and R₃ is a hydrocarbon group containing a hydroxyl group.

2. A recording paper according to claim 1, wherein two of the three substituents represented by R₁, R₂, and R₃ in the Formula (α) are hydrocarbon groups containing a hydroxyl group.

3. A recording paper according to claim 1, wherein the hydroxyl group is located at a terminal of the hydrocarbon group containing the hydroxyl group in the Formula (α).

4. A recording paper according to claim 1, wherein the hydrocarbon group containing a hydroxyl group in the Formula (α) is a hydrocarbon group containing a hydroxyalkyl group.

5. A recording paper according to claim 1, wherein the hydrocarbon group containing the hydroxyl group in the Formula (α) is a hydrocarbon group containing a straight chain hydroxyalkyl group having 1 to 5 carbon atoms.

6. A recording paper according to claim 1, wherein the amine represented by the Formula (α) is an amine represented by the following Formula (1): 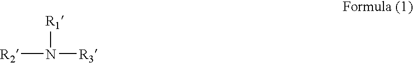
wherein at least one of three substituents represented by R₁′, R₂′, and R₃′ is a hydrocarbon group containing a hydroxyl group; and the three substituents represented by R₁′, R₂′, and R₃′ do not contain an alkyl group having —CO₂M or —SO₃M at terminals thereof, M being an atom or atomic group selected from the group consisting of hydrogen, alkali metals, alkali earth metals, ammonium, and organic amines.

7. A recording paper according to claim 1, wherein the amine represented by the Formula (α) is an amine represented by the following Formula (2): 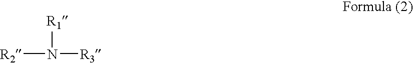
wherein at least one of three substituents represented by R₁″, R₂″, and R₃″ is a hydrocarbon group containing a hydroxyl group; and at least one of the three substituents represented by R₁″, R₂″, and R₃″ is a hydrocarbon group containing an alkyl group having —CO₂M or —SO₃M at a terminal thereof, M being an atom or atomic group selected from the group consisting of hydrogen, alkali metals, alkali earth metals, ammonium, and organic amines.

8. A recording paper according to claim 7, wherein the amine represented by the Formula (2) is an amine selected from N,N-bis(hydroxyalkyl)glycine derivatives, and N,N-bis(hydroxyalkyl)-2-aminoethanesulfonate derivatives.

9. A recording paper according to claim 1, wherein the amine represented by the Formula (α) has a melting point of 50° C. or more.

10. An ink jet recording method comprising ejecting an ink onto a recording paper and recording an image on the recording paper, wherein
the recording paper is a recording paper containing pulp fibers, a filler, and an amine, and
the amine is a primary, secondary, or tertiary amine represented by the following Formula (α): 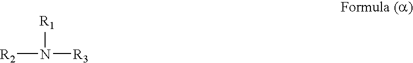
wherein at least one of substituents represented by R₁, R₂, and R₃ is a hydrocarbon group containing a hydroxyl group.

11. A ink jet recording method according to claim 10, wherein the ink contains a colorant.

12. A ink jet recording method according to claim 10, wherein a surface tension of the ink is in a range of about 20 to 37 mN/m.

13. An ink jet recording device provided with a recording head for ejecting ink onto a recording paper, wherein
the recording paper is a recording paper containing pulp fibers, a filler, and an amine and
the amine further is a primary, secondary, or tertiary amine represented by the following Formula (α): 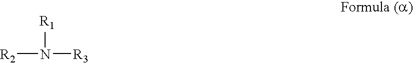
wherein at least one of substituents represented by R₁, R₂, and R₃ is a hydrocarbon group containing a hydroxyl group.

14. A ink jet recording device according to claim 13, wherein the ink contains a colorant.

15. A ink jet recording device according to claim 13, wherein a surface tension of the ink is in a range of about 20 to 37 mN/m.

16. An electrophotographic recording method, comprising:
electrically charging a surface of an electrostatic latent image bearing body;
exposing the surface of the electrostatic latent image bearing body to light to form an electrostatic latent image thereon;
developing the electrostatic latent image formed on the surface of the electrostatic latent image bearing body using an electrostatic image developer containing a toner to form a toner image;
transferring the toner image, directly or via an intermediate transfer body, onto a surface of a recording paper; and
fusing the toner image on the surface of the recording paper,
wherein the recording paper is a recording paper containing pulp fibers, a filler, and an amine, and
the amine is a primary, secondary, or tertiary amine represented by the following Formula (α): 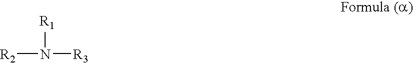
wherein at least one of substituents represented by R₁, R₂, and R₃ is a hydrocarbon group containing a hydroxyl group.

17. An electrophotographic recording device, comprising:
an electrostatic latent image bearing body;
a charging means that uniformly charges a surface of the electrostatic latent image bearing body;
an exposing means that exposes the surface of the electrostatic latent image bearing body to light and forms an electrostatic latent image;
a developing means that develops the electrostatic latent image formed on the surface of the electrostatic latent image bearing body using an electrostatic image developer and forms a toner image thereon;
a transferring means that transfers the toner image, directly or via an intermediate transfer body, onto a surface of a recording paper; and
a fusing means that fuses the toner image on the surface of the recording paper,
wherein the recording paper is a recording paper containing pulp fibers, a filler, and an amine, and 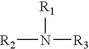
the amine is a primary, secondary, or tertiary amine represented by the following Formula (α): Formula (α)
wherein at least one of substituents represented by R₁, R₂, and R₃ is a hydrocarbon group containing a hydroxyl group.
